(19) United States
(12) Patent Application Publication
(10) Pub. No.: US 2025/0055392 A1
(43) Pub. Date: Feb. 13, 2025

(54) CIRCUIT AND METHOD FOR AUTOMATICALLY CALCULATING SPEED OF ROTOR

(71) Applicant: CRM ICBG (WUXI) CO., LTD., Wuxi, Jiangsu (CN)

(72) Inventors: Yafei LI, Wuxi (CN); Xudong ZHAO, Wuxi (CN); Chun HUA, Wuxi (CN); Xinjie LIU, Wuxi (CN)

(21) Appl. No.: 18/718,840

(22) PCT Filed: Feb. 24, 2023
(86) PCT No.: PCT/CN2023/078098

§ 371 Date: Jun. 12, 2024

(30) Foreign Application Priority Data
Mar. 9, 2022 (CN) 202210225740.X

(51) Int. Cl. H02P 6/17; G01P 3/66

(52) U.S. Cl. CPC H02P 6/17; G01P 3/66

(57) ABSTRACT

A circuit for automatically calculating a speed of a rotor includes: an edge generation module configured to receive Hall signals of three phases, and generate an edge response signal for the Hall signal of each phase; a counting module, which is connected to an output end of the edge generation module, configured to count the time difference between two adjacent jumps of the Hall signal of each phase on the basis of an output signal of the edge generation module to obtain a count value of each phase, output the current count value, and generate a trigger signal when the Hall signal of any phase jumps; and a division module, which is connected to an output terminal of the counting module, configured to divide an angle difference between the two adjacent jumps of the Hall signal by the current count value to obtain a rotation speed of an electric motor.

### CROSS-REFERENCE TO RELATED APPLICATIONS

This application claims priority to Chinese patent application No. 202210225740.X, entitled “CIRCUIT AND METHOD FOR AUTOMATICALLY CALCULATING SPEED OF ROTOR” and filed with the China Patent Office on Mar. 9, 2022, the content of which is hereby incorporated by reference in its entirety.

### TECHNICAL FIELD

The present disclosure relates to the field of electric motor control, and in particular, to a circuit and method for automatically calculating a speed of a rotor.

### BACKGROUND

Most prior arts use software to calculate a speed of a rotor of an electric motor, including the following steps.

In step I, a Hall sensor is mounted in the electric motor to feed back position information of the rotor of the electric motor.

In step II, a Hall deviation is compensated for.

In step III, a time difference between two adjacent jumps of a Hall signal is acquired.

In step IV, the time acquired in step III is filtered.

In step V, the speed of the rotor is calculated according to a changing angle of the rotor and the filtered time.

The above method relies heavily on the position information of the rotor. If there is a deviation, the speed of the rotor calculated may be inaccurate. The Hall sensor used in the prior art may generally have some mechanical deviations during the mounting, which causes a deviation in position angle estimation of the rotor, resulting in inaccurate calculation results. Therefore, the Hall deviation is required to be compensated for. Software compensation is used in most compensation methods, which requires a large number of algorithms such as a zero-order Taylor algorithm and a Fourier decoupling transform algorithm. The implementation process is relatively complex and difficult. In addition, since external factors such as air and ground roughness may affect the operation of the electric motor, after the time difference between two adjacent jumps of the Hall signal is acquired, there is a need to further perform RC filtering or average filtering on the time difference to eliminate accidental errors, which requires higher knowledge reserves of software personnel.

Further, the software takes a long time to calculate the speed of the rotor and is not friendly for functions that require strict time control (such as a field oriented control (FOC) mode). Moreover, complex software programs may also occupy a CPU for a long time, which is not conducive to other security controls.

Therefore, how to overcome the above problems has become one of the urgent problems for those skilled in the art.

### SUMMARY

In view of the above shortcomings of the prior art, an objective of the present disclosure is to provide a circuit and method for automatically calculating a speed of a rotor to solve the problems that the method for calculating a speed of a rotor in the prior art relies heavily on position information of the rotor, is cumbersome and complex to operate, takes a long time to calculate, is not friendly to functions that require strict time control, and occupies the CPU for a long time.

In order to achieve the above objective and other related objectives, the present disclosure provides a circuit for automatically calculating a speed of a rotor, wherein the circuit for automatically calculating a speed of a rotor includes at least:
an edge generation module configured to receive Hall signals of three phases, i.e. U, V and W, and respectively generate an edge response signal for the Hall signal of each phase;
a counting module, which is connected to an output terminal of the edge generation module, configured to count a time difference between two adjacent jumps of the Hall signal of each phase on the basis of an output signal of the edge generation module, so as to obtain a count value of each phase, output a current count value, and generate a trigger signal when the Hall signal of any phase jumps; and
a division module, which is connected to an output terminal of the counting module, configured to divide an angle difference between the two adjacent jumps of the Hall signal by the current count value, so as to obtain a rotation speed of an electric motor.

Optionally, the counting module includes a first counting unit, a second counting unit, a third counting unit, a selection unit, an OR logic unit, and a flip-flop;
the first counting unit, the second counting unit, and the third counting unit receiving a counting trigger signal and corresponding edge response signals and respectively counting the time difference between two adjacent jumps of the Hall signal of each phase to obtain a count value of each phase;
the selection unit being connected to output terminals of the first counting unit, the second counting unit, and the third counting unit, and receiving the edge response signals; when the Hall signals of more than two phases jump at the same time, outputting, according to a priority order of U, V and W, the count value corresponding to the Hall signal of the corresponding phase as the current count value; and when the Hall signal of each phase jumps respectively, outputting a count value corresponding to the jump as the current count value;
the OR logic unit receiving the edge response signals and performing an OR logic operation; and
the flip-flop being connected to an output terminal of the OR logic unit, and when an output signal of the OR logic unit is active, the flip-flop outputting the trigger signal.

Optionally, the first counting unit, the second counting unit, or the third counting unit includes a first selector, a second selector, a first D flip-flop, and an adder;
the first selector having a first input terminal connected to an output terminal of the first D flip-flop, a second input terminal connected to an output terminal of the adder, and a control terminal connected to the counting trigger signal;
the second selector having a first input terminal connected to an output terminal of the first selector, a second input terminal connected to a low-level signal, and a control terminal connected to the edge response signal for the Hall signal of the corresponding phase;
the first D flip-flop having a data input terminal connected to an output terminal of the second selector; and
the adder having an input terminal respectively connected to the output terminal of the first D flip-flop and a high-level signal, and when an output signal of the first D flip-flop is active, performing a plus one operation, and outputting the count value of the corresponding phase;
wherein signal output of the second input terminal is selected when a control signal of each selector is active, and signal output of the first input terminal is selected when the control signal is inactive.

More optionally, the selection unit includes a third selector, a fourth selector, and a fifth selector;
the third selector having a first input terminal connected to a low-level signal, a second input terminal connected to the output terminal of the first counting unit, and a control terminal connected to the edge response signal of the Hall signal of the phase W;
the fourth selector having a first input terminal connected to an output terminal of the third selector, a second input terminal connected to the output terminal of the second counting unit, and a control terminal connected to the edge response signal of the Hall signal of the phase V; and
the fifth selector having a first input terminal connected to an output terminal of the fourth selector, a second input terminal connected to the output terminal of the third counting unit, and a control terminal connected to the edge response signal of the Hall signal of the phase U;
wherein signal output of the second input terminal is selected when a control signal of each selector is active, and signal output of the first input terminal is selected when the control signal is inactive.

More optionally, the counting module further includes a filtering unit; the filtering unit being connected to output terminals of the selection unit and the OR logic unit, and receiving a counting upper limit and a counting lower limit; and when the Hall signal of any phase jumps and the current count value is between the counting upper limit and the counting lower limit, outputting the current count value.

More optionally, the filtering unit includes a first comparator, a second comparator, an AND logic gate, a sixth selector, and a second D flip-flop;
the first comparator having an input terminal respectively connected to the output terminal of the selection unit and a filtering lower limit, and outputting a first comparison result;
the second comparator having an input terminal respectively connected to the output terminal of the selection unit and a filtering upper limit, and outputting a second comparison result;
the AND logic gate having an input terminal respectively connected to output terminals of the first comparator, the second comparator, and the OR logic unit; and when the current count value is greater than or equal to the filtering lower limit and less than or equal to the filtering upper limit and the Hall signal of any phase jumps, the AND logic gate outputting an active filtering control signal;
the sixth selector having a first input terminal connected to an output terminal of the second D flip-flop, a second input terminal connected to the output terminal of the selection unit, and a control terminal connected to an output terminal of the AND logic gate; when the filtering control signal is active, the sixth selector selecting an output signal of the selection unit for output; and when the filtering control signal is inactive, the sixth selector selecting an output signal of the second D flip-flop for output; and
the second D flip-flop having a data input terminal connected to an output terminal of the sixth selector, and outputting a filtered current count value.

More optionally, the filtering lower limit and the filtering upper limit are provided by registers.

Optionally, the angle difference between the two adjacent jumps of the Hall signal is 180°.

In order to achieve the above objective and other related objectives, the present disclosure provides a method for automatically calculating a speed of a rotor, wherein the method for automatically calculating a speed of a rotor includes at least:
1) respectively generating edge response signals for Hall signals of three phases, i.e. U, V and W;
2) counting a time difference between two adjacent jumps of the Hall signal of each phase respectively on the basis of the edge response signal for the Hall signal of each phase, so as to obtain a count value of each phase, and outputting a current count value; and
3) dividing an angle difference between the two adjacent jumps of the Hall signal by the current count value, so as to calculate a rotation speed of an electric motor.

Optionally, in step 1), the edge response signal includes a rising edge response signal and a falling edge response signal.

Optionally, in step 2), the time difference between two adjacent jumps of the Hall signal of each phase is counted respectively; and when the Hall signals of more than two phases jump at the same time, the count value corresponding to the Hall signal of the corresponding phase is outputted as the current count value according to a priority order of U, V and W; and when the Hall signal of each phase jumps respectively, a count value corresponding to the jump is outputted as the current count value.

More optionally, step 2) further includes a step of filtering and outputting the current count value.

More optionally, the filtering method includes: when the Hall signal of any phase jumps and the current count value is between a counting upper limit and a counting lower limit, outputting the current count value; and filtering out the current count value otherwise.

As described above, the circuit and method for automatically calculating a speed of a rotor in the present disclosure achieve the following beneficial effects.

The circuit and method for automatically calculating a speed of a rotor in the present disclosure are based on a hardware circuit and use the jump of the Hall signal of a same phase to calculate the rotation speed, and filter the time difference by means of register writing; do not rely on the position information of the rotor, and achieve accurate calculation of the rotation speed; are convenient and simple to operate, do not impose high requirements on technical personnel, and can reduce the development time; do not require complex software programs and occupy few CPU resources; and are applicable to a wide range of scenarios, including an ideal condition, a Hall deviation condition, and a phase loss condition.

### BRIEF DESCRIPTION OF THE DRAWINGS

FIG. 1 is a schematic diagram of a relationship between angels of a rotor and Hall signals of three phases under an ideal condition;

FIG. 2 is a schematic diagram of a relationship between the angels of the rotor and the Hall signals of the three phases in the case of a Hall deviation;

FIG. 3 is a schematic diagram of a relationship between the angels of the rotor and the Hall signals of the three phases under a phase loss condition;

FIG. 4 is a schematic structural diagram of a circuit for automatically calculating a speed of a rotor according to the present disclosure;

FIG. 5 is a schematic structural diagram of a counting module according to the present disclosure; and

FIG. 6 is a schematic structural diagram of a first counting unit according to the present disclosure.

### REFERENCE SIGNS

1: circuit for automatically calculating a speed of a rotor
11: edge generation module
12: counting module
121: first counting unit
12a: first selector
12b: second selector
12c: first D flip-flop
12d: adder
122: second counting unit
123: third counting unit
124: selection unit
12e: third selector
12f: fourth selector
12g: fifth selector
125: OR logic unit
126: flip-flop
127: filtering unit
12h: first comparator
12i: second comparator
12j: AND logic gate
12k: sixth selector
121: second D flip-flop
13: division module
14: CPU

### DETAILED DESCRIPTION

Implementations of the present disclosure are illustrated below through specific examples, and other advantages and effects of the present disclosure can be easily understood by those skilled in the art through the contents disclosed in this specification. The present disclosure may also be implemented or applied through other different specific implementations. Various details in this specification may also be modified or changed in various manners based on different viewpoints and applications without departing from the spirit of the present disclosure.

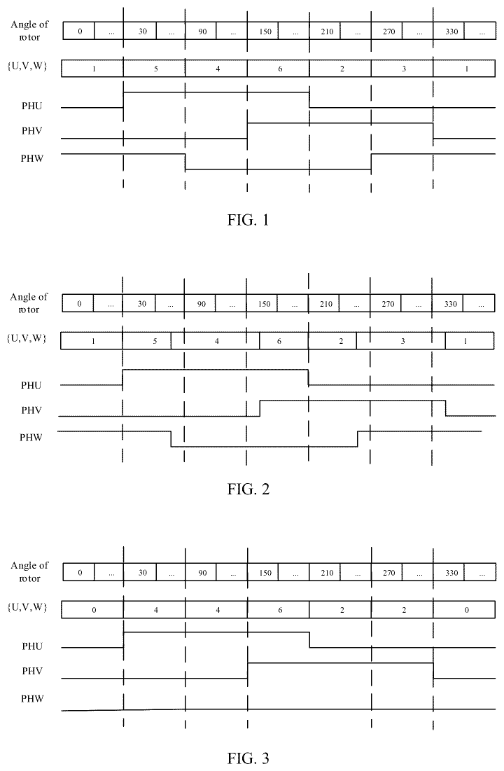

Refer to FIG. 1 to FIG. 6. It is to be noted that the diagrams provided in the following embodiments merely schematically illustrate the basic concept of the present disclosure, and only the components related to the present disclosure are shown in the diagrams, so that the diagrams are not drawn in accordance with the number, shape and size of the components in actual implementations. The type, the number and the proportion of the components in the actual implementations can be arbitrarily changed, and layouts of the components may be more complex.

Three Hall sensors are evenly arranged at an electrical angle of 120° on an integrated circuit board at an end of an electric motor to feed back position information of a rotor of the electric motor. The Hall sensor generates a logic level of 0 or 1 according to polarity of a magnetic pole piece in a corresponding region. When the electric motor rotates, the Hall signals of the three phases {U, V, W}change periodically in order of 5, 4, 6, 2, 3, 1. Theoretically, an angle difference between each two adjacent Hall signals is 60°. As shown in FIG. 1, PHU is a U-phase Hall signal, PHV is a V-phase Hall signal, and PHW is a W-phase Hall signal. However, due to a Hall deviation, the Hall signal may lead or lag behind, making the angle difference between two adjacent Hall signals greater than 600 or less than 60°. As shown in FIG. 2, the V-phase Hall signal PHV lags behind, and the W-phase Hall signal PHW leads. Therefore, it is inaccurate to calculate the speed of the rotor by using the angle difference and the time difference between two adjacent jumps of the Hall signal. In addition, for a phase loss condition, as shown in FIG. 3, a phase loss occurs in the W-phase Hall signal PHW, and the angle difference between two adjacent Hall signals is no longer 60° and becomes 120°, 60°, 120°. In this case, the speed of the rotor calculated is also incorrect and cannot be used.

However, no matter how great the Hall deviation between the three Hall sensors is, the angle difference between two adjacent jumps of a same Hall signal is fixed. As shown in FIG. 1 and FIG. 2, regardless of the ideal situation or the leading or lagging situation, the angle difference between two adjacent jumps of the U-phase Hall signal PHU is 180°, as is the V-phase Hall signal PHV and the W-phase Hall signal PHW. For the phase loss condition, except for the W-phase Hall signal PHW in which the phase loss occurs, the angle difference between two adjacent jumps of each of the other two phases is 180°.

In the present disclosure, the speed of the rotor is calculated based on the angle difference and the time difference between two adjacent jumps of a same Hall signal to obtain an accurate speed of the rotor, which prevents a complex procedure of compensating for the Hall deviation and is simple and convenient to operate. Specific solutions of the present disclosure are shown as follows.

### Embodiment 1

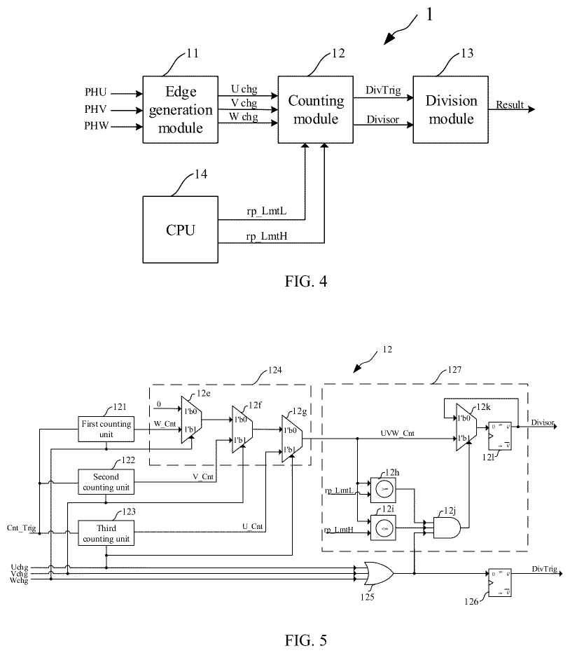

As shown in FIG. 4, this embodiment provides a circuit 1 for automatically calculating a speed of a rotor. The circuit 1 for automatically calculating a speed of a rotor includes:
an edge generation module 11, a counting module 12, and a division module 13.

As shown in FIG. 4, the edge generation module 11 receives Hall signals of three phases, i.e. U, V and W, and respectively generates a corresponding edge response signal for the Hall signal of each phase.

Specifically, the edge generation module 11 receives the U-phase Hall signal PHU, the V-phase Hall signal PHV, and the W-phase Hall signal PHW. The edge generation module 11 responds to a rising edge and a falling edge of the W-phase Hall signal PHW and generates a first edge response signal Wchg; responds to a rising edge and a falling edge of the V-phase Hall signal PHV and generates a second edge response signal Vchg; and responds to a rising edge and a falling edge of the U-phase Hall signal PHU and generates a third edge response signal Uchg. Any circuit structure that can realize double-edge (a rising edge and a falling edge) detection is applicable to the present disclosure, which is not described in detail herein. For example, when the Hall signal jumps, a corresponding pulse signal is generated as an edge response signal.

As shown in FIG. 4, the counting module 12 is connected to an output terminal of the edge generation module 11, counts a time difference between two adjacent jumps of the Hall signal of each phase on the basis of an output signal of the edge generation module 11, so as to obtain a count value of each phase, outputs a current count value, and generates a trigger signal DivTrig when the Hall signal of any phase jumps.

Specifically, as shown in FIG. 5, in this embodiment, the counting module 12 includes a first counting unit 121, a second counting unit 122, a third counting unit 123, a selection unit 124, an OR logic unit 125, and a flip-flop 126.

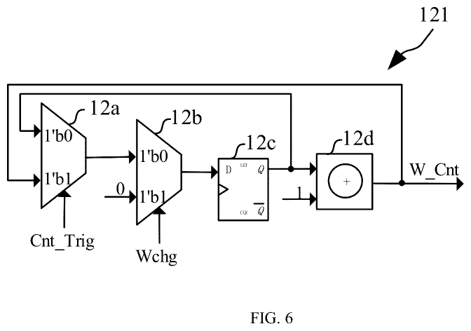

More specifically, as shown in FIG. 5, the first counting unit 121, the second counting unit 122, and the third counting unit 123 receive a counting trigger signal Cnt_trig and corresponding edge response signals and respectively count the time difference between two adjacent jumps of the Hall signal of each phase to obtain a count value of each phase. The first counting unit 121 receives the first edge response signal Wchg and the counting trigger signal Cnt_trig, and counts the time difference between two adjacent jumps of the W-phase Hall signal PHW. The second counting unit 122 receives the second edge response signal Vchg and the counting trigger signal Cnt_trig, and counts the time difference between two adjacent jumps of the V-phase Hall signal PHV. The third counting unit 123 receives the third edge response signal Uchg and the counting trigger signal Cnt_trig, and counts the time difference between two adjacent jumps of the U-phase Hall signal PHU. For example, as shown in FIG. 6, the first counting unit 121 includes a first selector 12a, a second selector 12b, a first D flip-flop 12c, and an adder 12d. The first selector 12a has a first input terminal connected to an output terminal of the first D flip-flop 12c, a second input terminal connected to an output terminal of the adder 12d, and a control terminal connected to the counting trigger signal Cnt_trig. The second selector 12b has a first input terminal connected to an output terminal of the first selector 12a, a second input terminal connected to a low-level signal “0”, and a control terminal connected to the first edge response signal Wchg. The first D flip-flop 12c has a data input terminal D connected to an output terminal of the second selector 12b. The adder 12d has an input terminal respectively connected to the output terminal of the first D flip-flop 12c and a high-level signal “1”, and when an output signal of the first D flip-flop 12c is active, a plus one operation is performed, and the adder 12d outputs a W-phase count value W_Cnt. Signal output of the second input terminal is selected when a control signal of each selector is active, and signal output of the first input terminal is selected when the control signal is inactive. Structures of the second counting unit 122 and the third counting unit 123 are the same as the structure of the first counting unit 121, and differences are as follows. In the second counting unit 122, the control terminal of the second selector 12b receives the second edge response signal Vchg, and the V-phase count value V_Cnt is finally outputted. In the third counting unit 123, the control terminal of the second selector 12b receives the third edge response signal Uchg, and a U-phase count value U_Cnt is finally outputted. Specific structures are not described in detail herein.

It is to be noted that any circuit structure that can count the time difference between two adjacent jumps of the Hall signal is applicable to the present disclosure. Further, the structures of the first counting unit 121, the second counting unit 122, and the third counting unit 123 may be different and are not limited to this embodiment.

More specifically, as shown in FIG. 5, the selection unit 124 is connected to output terminals of the first counting unit 121, the second counting unit 122, and the third counting unit 123, and receives the edge response signals. When the Hall signals of more than two phases jump at the same time, the count value corresponding to the Hall signal of the corresponding phase outputted as the current count value UVW_Cnt (for example, if the phase U and the phase V jump at the same time, the count value corresponding to the U-phase Hall signal is outputted as the current count value UVW_Cnt) according to a priority order of U, V and W (the phase U has the highest priority, followed by the phase V and then the phase W). When the Hall signal of each phase jumps respectively, a count value corresponding to the jump is outputted as the current count value UVW_Cnt. For example, the selection unit 124 includes a third selector 12e, a fourth selector 12f, and a fifth selector 12g. The third selector 12e has a first input terminal connected to a low-level signal “0”, a second input terminal connected to the W-phase count value W_Cnt outputted by the first counting unit 121, and a control terminal connected to the first edge response signal Wchg. The fourth selector 12f has a first input terminal connected to an output terminal of the third selector 12e, a second input terminal connected to the V-phase count value V_Cnt outputted by the second counting unit 122, and a control terminal connected to the second edge response signal Vchg. The fifth selector 12g has a first input terminal connected to an output terminal of the fourth selector 12f, a second input terminal connected to the U-phase count value U_Cnt outputted by the third counting unit 123, and a control terminal connected to the third edge response signal Uchg. Moreover, the selection unit 124 finally outputs the current count value UVW_Cnt. Signal output of the second input terminal is selected when a control signal of each selector is active, and signal output of the first input terminal is selected when the control signal is inactive.

It is to be noted that any circuit structure that can realize the above functions is applicable to the selection unit of the present disclosure, and is not limited to this embodiment. Under a normal operating state, the Hall signals of the three phases U, V and W jump alternately and periodically, and the count values corresponding to the Hall signals of the three phases are outputted in sequence according to a jump order. When one phase is lost, the count values corresponding to the Hall signals of the phases not lost are outputted in sequence according to the jump order. When two phases are lost, the count value corresponding to the Hall signal of the phase not lost is outputted.

More specifically, as shown in FIG. 5, the OR logic unit 125 receives the edge response signals and performs an OR logic operation. When any one of the first edge response signal Wchg, the second edge response signal Vchg, and the third edge response signal Uchg is active, an output signal of the OR logic unit 125 is active (active high). For example, the OR logic unit 125 is implemented using a three-input OR gate. In actual use, OR logic may be implemented based on a plurality of logic elements and is not limited to this embodiment.

More specifically, as shown in FIG. 5, the flip-flop 126 is connected to an output terminal of the OR logic unit 125, and when an output signal of the OR logic unit 125 is active, the flip-flop 126 outputs the trigger signal DivTrig. That is, when the Hall signal of any phase jumps, the trigger signal DivTrig is active.

More specifically, as another implementation of the present disclosure, as shown in FIG. 5, the counting module 12 further includes a filtering unit 127, and the filtering unit 127 is connected to output terminals of the selection unit 124 and the OR logic unit 125, and receives a counting upper limit rp_LmtH and a counting lower limit rp_LmtL. When the Hall signal of any phase jumps and the current count value UVW_Cnt is between the counting upper limit rp_LmtH and the counting lower limit rp_LmtL (including endpoint values rp_LmtH and rp_LmtL), the current count value UVW_Cnt is outputted. For example, the filtering unit 127 includes a first comparator 12h, a second comparator 12i, an AND logic gate 12j, a sixth selector 12k, and a second D flip-flop 121. The first comparator 12h has an input terminal respectively connected to the output terminal of the selection unit 124 and a filtering lower limit rp_LmtL, and outputs a first comparison result. The second comparator 12i has an input terminal respectively connected to the output terminal of the selection unit 124 and a filtering upper limit rp_LmtH, and outputs a second comparison result. The AND logic gate 12j has an input terminal respectively connected to output terminals of the first comparator 12h, the second comparator 12i, and the OR logic unit 125. When the current count value UVW_Cnt is greater than or equal to the filtering lower limit rp_LmtL and less than or equal to the filtering upper limit rp_LmtH and the Hall signal of any phase jumps, an active filtering control signal is outputted. The sixth selector 12k has a first input terminal connected to an output terminal of the second D flip-flop 121, a second input terminal connected to the output terminal of the selection unit 124, and a control terminal connected to an output terminal of the AND logic gate 12j. When the filtering control signal is active, the sixth selector 12k selects an output signal of the selection unit 124 for output. When the filtering control signal is inactive, the sixth selector 12k selects an output signal of the second D flip-flop 121 for output. The second D flip-flop 121 has a data input terminal D connected to an output terminal of the sixth selector 12k, and outputs a filtered current count value Divisor.

It is to be noted that the filtering lower limit rp_LmtL and the filtering upper limit rp_LmtH are provided by registers. In this embodiment, the registers are provided in a CPU 14, as shown in FIG. 4. In actual use, positions of the registers may be arranged as required. Any circuit structure that can realize the above filtering function is applicable to the present disclosure, and is not limited to this embodiment. In the present disclosure, only two registers are required to exclude unreasonable count values to achieve a filtering purpose. No complex software programs are required, the operation is convenient and simple, the calculation time is short, and the occupancy time of the CPU can also be reduced.

As shown in FIG. 4, the division module 13 is connected to an output terminal of the counting module 12, and divides an angle difference between the two adjacent jumps of the Hall signal by the count value outputted by the counting module 12, so as to obtain a rotation speed Result of an electric motor.

Specifically, the angle difference between the two adjacent jumps of the Hall signal is 180°. When the trigger signal DivTrig is active (for example, the trigger signal DivTrig is active high), the rotation speed Result of the electric motor may be obtained by dividing the angle difference between the two adjacent jumps of the Hall signal by the time difference between two adjacent jumps of a same Hall signal. The implementation of the trigger module is not limited and is not described in detail herein. In this embodiment, the count value outputted by the counting module 12 is the filtered current count value Divisor. In actual use, the count value outputted by the counting module 12 may alternatively be the current count value UVW_Cnt.

An operating principle of the present disclosure is as follows.

Ideally, mounting positions of the three Hall sensors are precise, the three phases UVW all operate normally, and the Hall signals can accurately reflect position information of the rotor. In this case, the angle difference between two adjacent jumps of each of the three phases UVW is 180°, the count values of the three phases U_Cnt, V_Cnt, and W_Cnt are all normal, and the rotation speed can be accurately calculated 6 times in a cycle of the operation of the electric motor.

In the case of a Hall deviation, position information of the rotor reflected by the Hall signals deviates, but the three phases UVW can all operate. In this case, the angle difference between two adjacent jumps of each of the three phases UVW is 180°, the count values of the three phases U_Cnt, V_Cnt, and W_Cnt are all normal, and the rotation speed can be accurately calculated 6 times in a cycle of the operation of the electric motor.

In the case of a phase loss, if the phase U is lost and the phase V and the phase W operate, the angle difference between two adjacent jumps of either of the phase V and the phase W is 180°, the count values of the phase V and the phase W V_Cnt and W_Cnt are normal, and the rotation speed can be accurately calculated 4 times in a cycle of the operation of the electric motor. If the phase U and the phase V are lost and the phase W operates, the angle difference between two adjacent jumps of the phase W is 180°, the count value of the phase W W_Cnt is normal, and the rotation speed can be accurately calculated 2 times in a cycle of the operation of the electric motor.

As can be seen, the present disclosure is flexible and quick to operate and has a wide range of applications, which is applicable to ideal situations as well as to Hall deviation and phase loss situations.

### Embodiment 2

This embodiment provides a method for automatically calculating a speed of a rotor. For example, the method for automatically calculating a speed of a rotor is implemented based on the circuit for automatically calculating a speed of a rotor in Embodiment 1. In actual use, any hardware or software apparatus that can implement the method is applicable. The method for automatically calculating a speed of a rotor includes at least the following steps.
1) Edge response signals for Hall signals of three phases, i.e. U, V and W, are respectively generated.

Specifically, the Hall signal of each phase corresponds to an edge response signal, and the edge response signal includes a rising edge response signal and a falling edge response signal. For example, when the Hall signal jumps, a pulse signal is generated. The jump of the Hall signal includes a rising edge jump and a falling edge jump. That is, when the Hall signal jumps to a rising edge or a falling edge, a corresponding pulse signal may be generated.
2) A time difference between two adjacent jumps of the Hall signal of each phase is counted respectively on the basis of the edge response signal for the Hall signal of each phase, so as to obtain a count value of each phase, and a current count value is outputted.

Specifically, the time difference between two adjacent jumps of the Hall signal of each phase is counted respectively. For the Hall signal of any phase, counting starts when a current pulse of the edge response signal is received, and counting is restarted when a next pulse is received, and so on. The count value is continuously updated.

Specifically, in this embodiment, the current count value UVW_Cnt is obtained by selecting an output order of the count values of the three phases. In this case, when the Hall signals of more than two phases jump at the same time, the count value corresponding to the corresponding Hall signal is outputted according to a priority order of U, V and W. For example, when the Hall signals of the three phases jump at the same time, the count value of the phase U is outputted. When the phase U and the phase V jump at the same time, the count value of the phase U is outputted. When the phase U and the phase W jump at the same time, the count value of the phase U is outputted. When the phase V and the phase W jump at the same time, the count value of the phase V is outputted. In a normal state, the situation where the Hall signals of more than two phases jump at the same time may not occur. If this situation happens, it indicates that a phase loss or other faults occur. Moreover, this situation may not last for a long time. In most of the time, the Hall signal of each phase jumps separately. When the Hall signal of each phase jumps separately, the count value corresponding to the jump is outputted. That is, if the Hall signal of any phase is outputted and jumps, the count value corresponding to the Hall signal of the phase is outputted.

Specifically, as an implementation of the present disclosure, a step of filtering and outputting the current count value UVW_Cnt is further included. When the Hall signal of any phase jumps and the current count value UVW_Cnt is between a counting upper limit rp_LmtH and a counting lower limit rp_LmtL, the current count value is outputted, and is filtered out otherwise, so as to improve accuracy of the final result.

It is to be noted that the counting upper limit rp_LmtH and the counting lower limit rp_LmtL are provided by registers. There is no need for software personnel to write complex filtering software programs based on motor theory and mathematical theory, and the operation is convenient and simple.
3) An angle difference between the two adjacent jumps of the Hall signal is divided by the current count value, so as to calculate a rotation speed of an electric motor.

Specifically, the angle difference between the two adjacent jumps of the Hall signal is 180°, and the current rotation speed Result of the electric motor may be obtained by dividing 180° by the current count value. In the method, the rotation speed of the electric motor is calculated based on the signal of the same Hall sensor, which does not rely on the position information of the rotor, and does not affect accuracy of calculation of the speed of the rotor. In addition, even if phases of two Hall sensors are lost, the speed of the rotor can be accurately calculated as long as one Hall sensor operates. Therefore, the present disclosure is more widely applicable.

It is to be noted that after the filtering operation is performed in step 2), in step 3), 180° is divided by the filtered current count value Divisor, which is not described in detail herein.

Based on the above, the present disclosure provides a circuit and method for automatically calculating a speed of a rotor. The circuit includes: an edge generation module, which is used for receiving Hall signals of three phases, i.e. U, V and W, and respectively generating an edge response signal for the Hall signal of each phase; a counting module, which is connected to an output terminal of the edge generation module, counts a time difference between two adjacent jumps of the Hall signal of each phase on the basis of an output signal of the edge generation module, so as to obtain a count value of each phase, outputs a current count value, and generates a trigger signal when the Hall signal of any phase jumps; and a division module, which is connected to an output terminal of the counting module, and divides an angle difference between the two adjacent jumps of the Hall signal by the current count value, so as to obtain a rotation speed of an electric motor. The circuit and method for automatically calculating a speed of a rotor in the present disclosure are based on a hardware circuit and use the jump of the Hall signal of a same phase to calculate the rotation speed, and filter the time difference by means of register writing; do not rely on the position information of the rotor, and achieve accurate calculation of the rotation speed; are convenient and simple to operate, do not impose high requirements on technical personnel, and can reduce the development time; do not require complex software programs and occupy few CPU resources; and are applicable to a wide range of scenarios, including an ideal condition, a Hall deviation condition, and a phase loss condition. Therefore, the present disclosure effectively overcomes various shortcomings in the prior art and has high industrial utilization value.

The above embodiments only illustrate the principles and effects of the present disclosure, but are not intended to limit the present disclosure. Any person skilled in the art can modify or change the above embodiments without departing from the spirit and scope of the present disclosure. Therefore, all equivalent modifications or changes made by those of ordinary skill in the art without departing from the spirit and technical ideas disclosed in the present disclosure shall still be covered by the claims of the present disclosure.

1. A circuit for automatically calculating a speed of a rotor, wherein the circuit for automatically calculating the speed of the rotor comprises at least:
an edge generation module configured to receive Hall signals of three phases, i.e. U, V and W, and respectively generate an edge response signal for the Hall signal of each phase;
a counting module, which is connected to an output terminal of the edge generation module, configured to count a time difference between two adjacent jumps of the Hall signal of each phase on the basis of an output signal of the edge generation module, so as to obtain a count value of each phase, output a current count value, and generate a trigger signal when the Hall signal of any phase jumps; and
a division module, which is connected to an output terminal of the counting module, configured to divide an angle difference between the two adjacent jumps of the Hall signal by the current count value, so as to obtain a rotation speed of an electric motor.

2. The circuit for automatically calculating the speed of the rotor according to claim 1, wherein the counting module comprises a first counting unit, a second counting unit, a third counting unit, a selection unit, an OR logic unit, and a flip-flop;
the first counting unit, the second counting unit, and the third counting unit receiving a counting trigger signal and corresponding edge response signals and respectively counting the time difference between two adjacent jumps of the Hall signal of each phase to obtain a count value of each phase;
the selection unit being connected to output terminals of the first counting unit, the second counting unit, and the third counting unit, and receiving the edge response signals; when the Hall signals of more than two phases jump at the same time, outputting, according to a priority order of U, V and W, the count value corresponding to the Hall signal of the corresponding phase as the current count value; and when the Hall signal of each phase jumps respectively, outputting a count value corresponding to the jump as the current count value;
the OR logic unit receiving the edge response signals and performing an OR logic operation; and
the flip-flop being connected to an output terminal of the OR logic unit, and when an output signal of the OR logic unit is active, the flip-flop outputting the trigger signal.

3. The circuit for automatically calculating the speed of the rotor according to claim 2, wherein the first counting unit, the second counting unit, or the third counting unit comprises a first selector, a second selector, a first D flip-flop, and an adder;
the first selector having a first input terminal connected to an output terminal of the first D flip-flop, a second input terminal connected to an output terminal of the adder, and a control terminal connected to the counting trigger signal;
the second selector having a first input terminal connected to an output terminal of the first selector, a second input terminal connected to a low-level signal, and a control terminal connected to the edge response signal for the Hall signal of the corresponding phase;
the first D flip-flop having a data input terminal connected to an output terminal of the second selector; and
the adder having an input terminal respectively connected to the output terminal of the first D flip-flop and a high-level signal, and when an output signal of the first D flip-flop is active, performing a plus one operation, and outputting the count value of the corresponding phase;
wherein signal output of the second input terminal is selected when a control signal of each selector is active, and signal output of the first input terminal is selected when the control signal is inactive.

4. The circuit for automatically calculating the speed of the rotor according to claim 2, wherein the selection unit comprises a third selector, a fourth selector, and a fifth selector;
the third selector having a first input terminal connected to a low-level signal, a second input terminal connected to the output terminal of the first counting unit, and a control terminal connected to the edge response signal of the Hall signal of the phase W;
the fourth selector having a first input terminal connected to an output terminal of the third selector, a second input terminal connected to the output terminal of the second counting unit, and a control terminal connected to the edge response signal of the Hall signal of the phase V; and
the fifth selector having a first input terminal connected to an output terminal of the fourth selector, a second input terminal connected to the output terminal of the third counting unit, and a control terminal connected to the edge response signal of the Hall signal of the phase U;
wherein signal output of the second input terminal is selected when a control signal of each selector is active, and signal output of the first input terminal is selected when the control signal is inactive.

5. The circuit for automatically calculating the speed of the rotor according to claim 2, wherein the counting module further comprises a filtering unit; the filtering unit being connected to output terminals of the selection unit and the OR logic unit, and receiving a counting upper limit and a counting lower limit; and when the Hall signal of any phase jumps and the current count value is between the counting upper limit and the counting lower limit, outputting the current count value.

6. The circuit for automatically calculating the speed of the rotor according to claim 5, wherein the filtering unit comprises a first comparator, a second comparator, an AND logic gate, a sixth selector, and a second D flip-flop;
the first comparator having an input terminal respectively connected to the output terminal of the selection unit and a filtering lower limit, and outputting a first comparison result;
the second comparator having an input terminal respectively connected to the output terminal of the selection unit and a filtering upper limit, and outputting a second comparison result;
the AND logic gate having an input terminal respectively connected to output terminals of the first comparator, the second comparator, and the OR logic unit; and when the current count value is greater than or equal to the filtering lower limit, and less than or equal to the filtering upper limit, and the Hall signal of any phase jumps, the AND logic gate outputting an active filtering control signal;
the sixth selector having a first input terminal connected to an output terminal of the second D flip-flop, a second input terminal connected to the output terminal of the selection unit, and a control terminal connected to an output terminal of the AND logic gate; when the filtering control signal is active, the sixth selector selecting an output signal of the selection unit for output; and when the filtering control signal is inactive, the sixth selector selecting an output signal of the second D flip-flop for output; and
the second D flip-flop having a data input terminal connected to an output terminal of the sixth selector, and outputting a filtered current count value.

7. The circuit for automatically calculating the speed of the rotor according to claim 5, wherein the filtering lower limit and the filtering upper limit are provided by registers.

8. The circuit for automatically calculating the speed of the rotor according to claim 1, wherein the angle difference between the two adjacent jumps of the Hall signal is 180°.

9. The circuit for automatically calculating the speed of the rotor according to claim 1, wherein the edge generation module responds to a rising edge and a falling edge of the Hall signal of each phase to generate the edge response signal.

10. The circuit for automatically calculating the speed of the rotor according to claim 2, wherein when any one of the edge response signals is active, the output signal of the OR logic unit is active.

11. A method for automatically calculating a speed of a rotor, wherein the method for automatically calculating the speed of the rotor comprises at least:
1) respectively generating edge response signals for Hall signals of three phases, i.e. U, V and W;
2) counting a time difference between two adjacent jumps of the Hall signal of each phase respectively on the basis of the edge response signal for the Hall signal of each phase, so as to obtain a count value of each phase, and outputting a current count value; and
3) dividing an angle difference between the two adjacent jumps of the Hall signal by the current count value, so as to calculate a rotation speed of an electric motor.

12. The method for automatically calculating the speed of the rotor according to claim 11, wherein in step 1), the edge response signal comprises a rising edge response signal and a falling edge response signal.

13. The method for automatically calculating the speed of the rotor according to claim 11, wherein in step 2), the time difference between two adjacent jumps of the Hall signal of each phase is counted respectively; and when the Hall signals of more than two phases jump at the same time, the count value corresponding to the Hall signal of the corresponding phase is outputted as the current count value according to a priority order of U, V and W; and when the Hall signal of each phase jumps respectively, a count value corresponding to the jump is outputted as the current count value.

14. The method for automatically calculating the speed of the rotor according to claim 11, wherein step 2) further comprises a step of filtering and outputting the current count value.

15. The method for automatically calculating the speed of the rotor according to claim 14, wherein the filtering method comprises: when the Hall signal of any phase jumps and the current count value is between a counting upper limit and a counting lower limit, outputting the current count value; and filtering out the current count value otherwise.
